(19) United States
(12) Patent Application Publication
(10) Pub. No.: US 2003/0110032 A1
(43) Pub. Date: Jun. 12, 2003

(54) Fast search in speech recognition

(76) Inventor: Frank Torsten Bernd Seide, Beijing (CN)

Correspondence Address: U.S. Philips Corporation, 580 White Plains Road, Tarrytown, NY, 10591, US

(21) Appl. No.: 10/188,764

(22) Filed: Jul. 3, 2002

(30) Foreign Application Priority Data
Jul. 6, 2001 (EP) 01202609.2

(51) Int. Cl. G10L 15/12; G10L 15/08

(52) U.S. Cl. 704/240; 704/254

(57) ABSTRACT

Speech recognition involves searching for the most likely one of a number of sequences of words, given a speech signal. Each such sequence is a composite sequence, composed of consecutive sequences of states. Searching involves a number of searches, each in a respective search space containing a subset of the sequences of states. In each search only the more likely sequences of states in the relevant search space are considered. In a first embodiment different search spaces are made up of sequences of states that follow preceding sequences from a class of sequences of words. Different classes define different ones of the search spaces. Classes are distinguished on the basis of phonetic history rather than word history, as represented by the sequences of states in the composite sequence up to the sequence of states in the search space. Thus, the number of words or parts thereof whose identity is used to distinguish different classes is varied depending on a length of one or more last words represented by the composite sequence. In a second embodiment, a plurality different composite sequences are involved in a search through a joint sequence of states, for which representative likelihood information for the plurality is used to decide whether or not to discard it in the search. At the end of the search the likelihood for the different composite sequences is regenerated from the joint sequence if it survived the search, and further search is based on the regenerated likelihood. In a third embodiment, this technique is applied within searches at the subword level.

The purpose of computerized continuous speech recognition is to identify a sequence of words that most likely corresponds to a series of observed segments of a speech signal. Each word is represented by a sequence of states that are generated as representations of the speech signal. As a result recognition involves searching for a more likely composite sequence of sequences of states among different sequences that correspond to different words. Key performance properties of speech recognition are the reliability of the results of this search and the computational effort needed to perform it. These properties depend in opposite ways on the number of sequences (the search space) that is involved in the search: a larger number of sequences gives more reliable results but requires more computational effort and vice versa. Recognition techniques strive for efficient search techniques that limit the size of the search with a minimum loss of reliability.

U.S. Pat. No. 5,995,930 discloses a speech recognition technique which uses a state level search, which searches for a more likely sequence of states among possible sequences of states. The state level search is most closely linked to the observed speech signal. This search involves a search among possible sequences of states that correspond to successive frames of the observed speech signal. The likelihood of different sequences is computed as a function of the observed speech signal. The more likely sequences are selected.

The computation of the likelihood is based on a model. This model conventionally has a linguistic component, which describes the apriori likelihood of different sequences of words, and a lexical component, which describes the apriori likelihood that different sequences of states occur given that a word occurs. Finally, the model specifies the likelihood that, given a state, properties of the speech signal in a time interval (frame) will have certain values. Thus, a speech signal is represented by a sequence of states and a sequence of words, the sequence of states being subdivided into (sub-)sequences for successive words. The aposteriori likelihood of these sequences is computed, given properties of the observed speech signal in successive frames.

To keep the computational efforts within reasonable limits, the searches disclosed in U.S. Pat. No. 5,995,930 are not exhaustive. Only candidate sequences of states and words that are expected to be more likely are considered. This is realized by a progressive likelihood limited search in which new candidate sequences are generated by extending previous sequences with new states. Only more likely previous sequences are extended: the likelihood of the previous sequences is used to limit the size of the search space. However, limiting the search space compromises reliability, because discarded less likely previous sequences, when extended, might still have become more likely sequences, often only after a number of states that corresponds to one or more words.

U.S. Pat. No. 5,995,930 splits the state level search into different searches in which likelihood limitation is conducted separately, that is, the more likely sequences in a search are extended, irrespective of whether other searches contain more likely sequences. To understand how different searches are distinguished, suppose a sequence of states has been generated that ends in a terminal state for a word, so that the final part of the sequence of states corresponds to a sequence of words. These last N words of that sequence of words are used to define a search for a subsequent sequence of states. (N being the number of successive words for which the linguistic model specifies likelihoods; N=1, 2, . . . , but typically 3 or larger). Different searches are started, each for a different previous “history” of N words. Thus, each search contains sequences of states that start with states that follow sequences that corresponds to the same history of N words. Different sequences in the same search may have different starting times. Thus, within each search it is possible to search for the most likely point in time where these most recently produced N words end.

In this way, the search for more likely sequences that are to be extended is performed a number of times, each time for sequences of states that correspond to a different history of N most recent words. Sequences that are discarded from the search are discarded for each search individually: a sequence of states following N particular words is not discarded in the search following those N words if this sequence of states is sufficiently likely following those N words, even if this sequence of states is less likely in view of the most likely sequence of N words.

Apart from allowing for word recognition, the split into word level searches and state level searches helps to limit the loss of reliability with a minimum of increased computational effort, because the use of word level histories allows control over selection of sequences over longer time spans in the speech signal than the state level search. Some less likely sequences of states, which might become more likely in the long run because of the likelihood their word context, are protected against discarding without an excessive increase in search space.

However, there is still a considerable increase in search space because different searches must be performed for different sets of most recent words. This implies a trade-off between reliability and computational effort: if one uses more most recent words to distinguish different searches, reliability increases, but more searches and hence more computational effort will be needed. If one uses only the single most recent word or a few most recent words to distinguish searches reliability decreases, because sequences of states that might become likely later risk being discarded.

Another trade-off between reliability and computational effort can be realized by means of two-pass method. The method just described is called a single pass method, because once the speech signal has been processed up to a certain time, the results of the search are directly available. In a two pass-algorithm one applies a second pass through the search results to find alternatives for the words that have been found in the first pass. In an article by Schwartz and Austin, published in the proceedings of the 1991 International Conference on Acoustics, Speech and Signal Processing (Toronto 1991), various two pass techniques are described to perform the search for word sequences efficiently and reliably.

Schwartz and Austin describe one solution to improve the single pass technique. In this solution words discarded in the word level search are stored in association with the retained words in whose favor the discarded words where discarded. In addition the likelihood of the discarded words at the point where they were discarded is stored. Once a most likely sequence of words has been found in the first pass, a second pass is executed in which likelihoods are computed for sequences of words obtained by replacing retained words in the sequence by discarded words (using the likelihood computed for those discarded words in the first pass). This technique reduces the risk of missing the most likely sequence of words, but the results are still unreliable, because the technique does not perform the state level search for the optimal time points between words following the discarded words.

Schwartz and Austin describe a improvement of the first pass of this technique in which they search for the most likely sequence of states following sequences that correspond to a preceding word. Separate searches are performed, each for a different preceding word, instead of only for the most likely preceding word. That is, the computation of likelihoods of states following sequences of states that represent less likely preceding words is not stopped immediately at the terminal states of these preceding words, but only once the most likely next word has been found that succeeds each less likely preceding word. This increases the reliability of the search, because it delays the point where a word sequence is discarded, reducing the risk of that an initially less likely word sequence is discarded before it becomes more likely. Furthermore it allows searching for the optimal time point to start the word following the preceding word. But the increase in reliability is at the expense of a larger search, because lexical states must be searched for each of a number of preceding words.

Amongst others, it is an object of the invention to make it possible to realize a better trade-off between reliability and computational effort in the search for sequences of states that most likely correspond to an observed speech signal.

In an embodiment the invention provides for a speech recognition method that comprises searching, among composite sequences that are each composed of consecutive sequences of states, for at least one of the composite sequences that is more likely to represent an observed speech signal than other ones of the composite sequences, said searching comprising

progressive, likelihood limited searches, each likelihood limited in a respective search space containing a subset of the sequences of states, for sequences of states of which the composite sequences will be composed;

the search spaces of different ones of the searches each comprising sequences of states that are to form part of a class composite sequences, different classes, defining different ones of the search spaces, being distinguished on the basis of an identity of a number of words or parts thereof represented by the sequences of states in the composite sequence up to the sequence of states in the search space, the number of words or parts thereof whose identity is used to distinguish different classes being varied depending on a length of one or more last words represented by the composite sequence up to the sequence in the search space, composite sequences that correspond to a same one or more last words are distinguished into different classes if the one or more of the last words are relatively shorter but are not distinguished into different classes if the one or more last words are relatively longer.

In this embodiment different state level searches are performed for sequences of states that are each preceded by different class of preceding sequences. Preferably, the classes are distinguished on the basis of different phonetic history rather than on the basis of different word history. A balance between reliability and computational effort is realized by flexibly adapting the length of word information that is used to distinguish different classes, and thereby different searches. The length in terms of the number of words or fractions thereof depends on the particular words used. If several preceding sequences of states correspond to sequences of words that end in the same short word (or N words), separate state level searches are executed for different ones of these sequences that differ in less recent words. On the other hand, if the most recent word or N words is or are longer, one state level search may be executed for all candidate sequences of words that end in that word or N words.

This prevents that too many searches need to be performed. If the preceding words are long a few words or parts of words suffice to define different searches with good reliability. If different sequences of preceding words ends in a short word, separate searches are used, following different preceding sequences that are distinguished by more parts of earlier words. Thus it is prevented that the reliability decreases in this case, for example because the selection of the starting time point of the most likely sequence in the search is affected by the earlier words of different preceding sequences following which the same search is performed.

Preferably, the selection of classes of preceding sequences following which different searches are performed is dependent on phonetic history and independent of the length of word history that is used to select more likely sequences at the linguistic level. Typically, linguistic models specify likelihoods for sequences of three or more words, whereas the same search is performed for sequences that share a number of phonemes that span much less than this number of words.

In an embodiment, a predetermined number of phonemes of words recognized in the preceding sequence is used distinguish different searches. Joint searches are performed for word histories end in the same N phonemes and separate searches are performed for word histories that differ in these N last phonemes, irrespective of the actual words of which these phonemes are part. This has the effect that the separation into searches is determined at the phonetic level rather than at the word level, and is therefore more reliable. Thus, separate state level searches may be defined for sequences of most recent candidate words that differ in a number of most recent phonemes, i.e. at fractions of words.

In another embodiment, the number of phonemes that is used to distinguish different searches is adapted to the nature of the phonemes, for example so that the phonemes that are used to distinguish different searches contain at least one syllable ending, or at least one vowel, or at least one consonant.

In another embodiment of the method according to the invention, reliability is increased without increased search space by performing at least part of a state level search using a single sequence of states that represents a class composite sequences. Representative likelihood information for the class is used to control discarding less likely sequences of states during the search. After (the part of) the search the likelihoods of individual members of the class are regenerated separately for use in further search. That is, selection of the representative likelihood does not have a lasting effect: discarding in the subsequent state level search is not necessarily controlled by the likelihood determined by the representative. Thus, a similar increase of reliability is realized as with a two pass search, in which discarded words are reconsidered, but this is done already in a first pass. There is an additional increase in reliability because the likelihood of individual members of the class is regenerated at the end of the search and used in further search without selecting a single member to the exclusion of the others. This reduces the risk reduced of wrongful state level discarding on the basis of a representative sequence of words that turns out to be less likely later.

Preferably, in this embodiment, the likelihood computed for a final state during the search, starting from the representative likelihood, is used to regenerate the likelihoods of the different members. Alternatively, these likelihoods might be recomputed for each individual member starting from the initial state, but this would involve more computational effort.

This embodiment is preferably combined with the embodiment wherein the phonetic history is used to select the classes that define searches. Thus, the phonetic selection of classes does not stand in the way of subsequent discarding of sequences on the basis of linguistic information is not significantly affect by the formation of classes, because the individual likelihoods of the members of the class are regenerated.

In another embodiment the search effort is reduced by proceeding with a single sequence of states to perform a part of a state level search following the end of a subword in a number of different preceding sequences of states. Preferably, the class of sequences for which the single search is performed is distinguished by the fact that the preceding sequences correspond to a shared set of most recent subwords. This set may extend across word boundaries, so that the trade-off between reliability and computational effort does not depend on whether a word boundary is crossed.

These and other objects and advantageous aspects of the invention will be described in more detail using the following drawing.

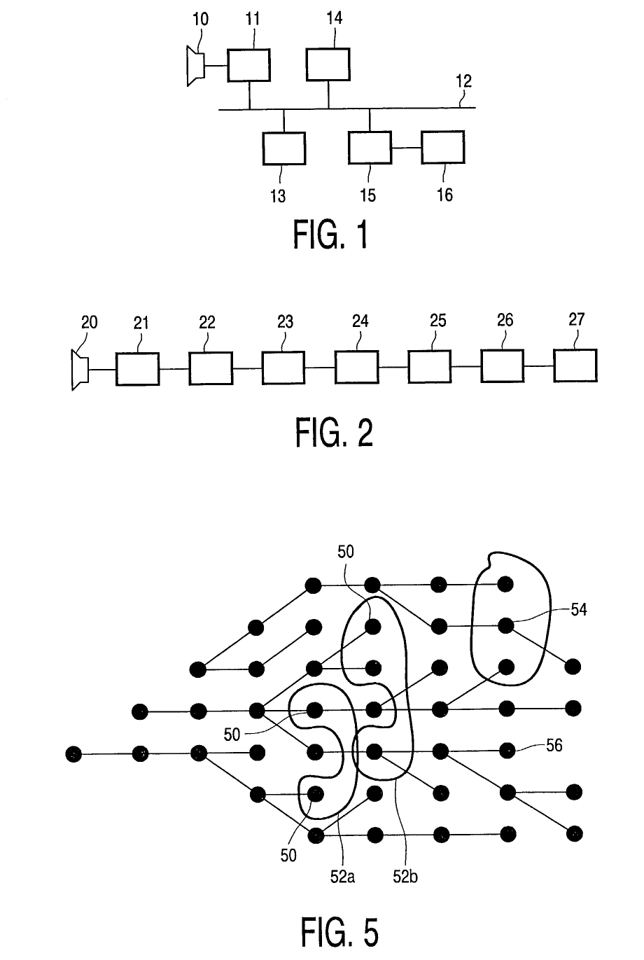

FIG. 1 shows a speech recognition system

FIG. 2 shows a further speech recognition system

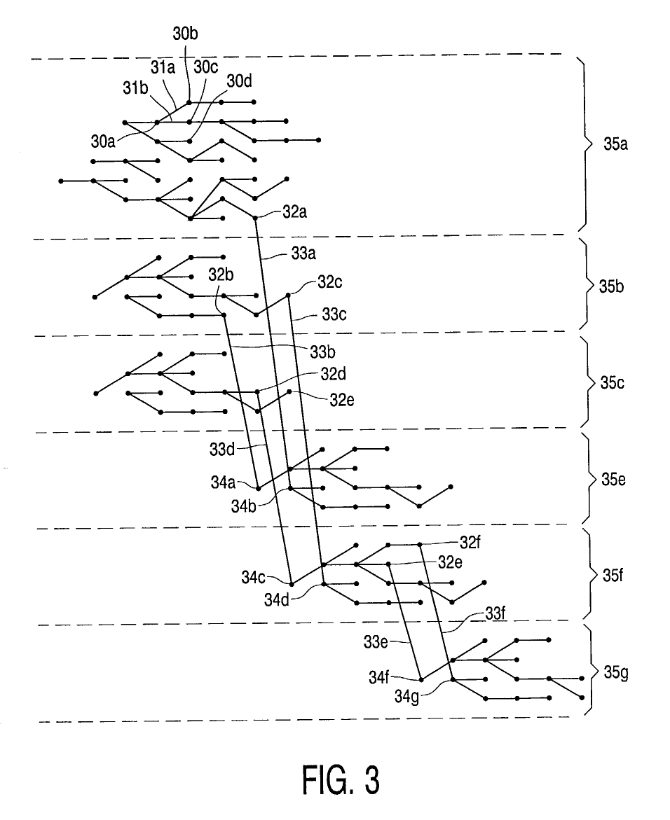

FIG. 3 illustrates sequences of states

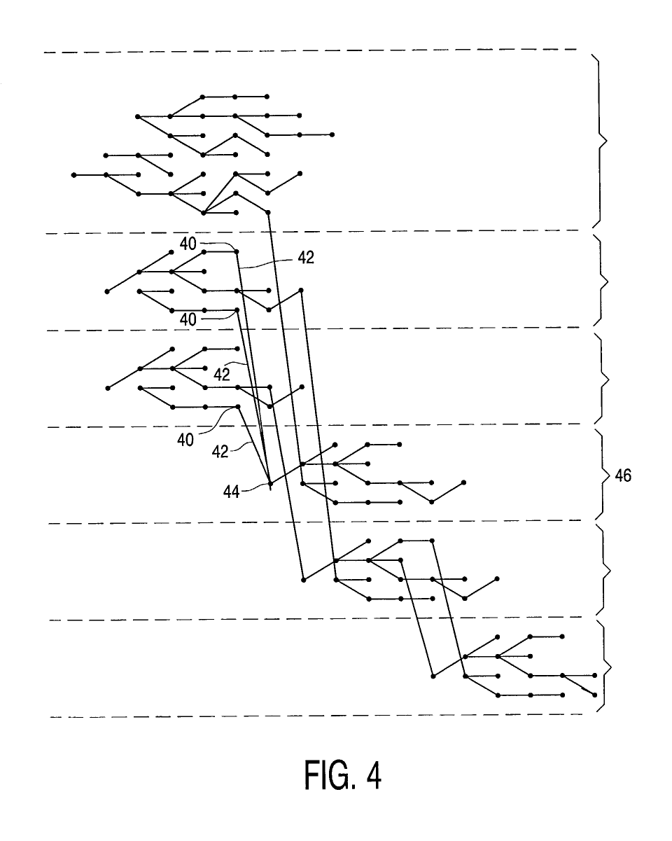

FIG. 4 illustrates further sequences of states

FIG. 5 illustrates application a technique at the subword level.

FIG. 1 shows an example of a speech recognition system. The system contains a bus 12 connecting a speech sampling unit 11, a memory 13, a processor 14 and a display control unit 15. A microphone 10 is coupled to the sampling unit 11. A monitor 16 is coupled to display control unit 15.

In operation, microphone 10 receives speech sounds and converts these sounds into an electrical signal, which is sampled by sampling unit 11. Sampling unit 11 stores samples of the signal into memory 13. Processor 14 reads the samples from memory 13 and computes and outputs data identifying sequences of words (e.g. codes for characters that represent the words) that most likely correspond to the speech sounds. Display control unit 15 controls monitor 16 to display graphical characters representing the words.

Of course, direct input from a microphone 10 and output to a monitor 16 are but one example of the use of speech recognition. One may use prerecorded speech instead of speech received from a microphone and the recognized words may be used for any purpose. The various functions performed in the system of FIG. 1 can be distributed over different hardware units in any way.

FIG. 2 shows a distribution of functions over a cascade of a microphone 20, a sampling unit 21, a first memory 22, a parameter extraction unit 23, a second memory 24, a recognition unit 25, a third memory 26 and a result processor 27. FIG. 2 can be seen as a representation with different hardware units that perform different functions, but the figure is also useful as a representation of software units, which may be implemented using various suitable hardware components, for example the components of FIG. 1.

In operation, the sampling unit 21 stores samples of a signal that represents speech sounds in first memory 22. Parameter extraction unit 23 segments the speech into time intervals and extracts sets of parameters, each for a successive time interval. The parameter describe the samples, for example in terms of a the intensity and relative frequency of peaks of the spectrum of the signal represented by the samples in the relevant time interval. Parameter extraction unit 23 stores the extracted parameters in second memory 24. Recognition unit 25 reads the parameters from second memory 24 and searches for a most likely sequence of words corresponding to the parameters of a series of time intervals. Recognition unit 25 outputs data identifying this most likely sequence to third memory 26. Result processor 27 reads this data for further use, such as in word processing or for controlling functions of a computer.

The invention is concerned primarily with the operation of recognition unit 25, or the recognition function performed by processor 14 or equivalents thereof. The recognition unit 25 computes word sequences on the basis of parameters for successive segments of the speech signal. This computation is based on a model of the speech signal.

Examples of such models are well known in the speech recognition art. For reference an example of such a model will be described briefly, but the skilled person will rely on the art to define the model. The example of a model is defined in terms of types of states. A state of a particular type corresponds with a certain probability to possible values of the parameter in a segment. This probability depends on the type of state and the parameter value and is defined by the model, for example after a learning phase in which the probability is estimated from example signals. It is not relevant for the invention how these probabilities are obtained.

The relation between the states and the words is modeled using a state level model (lexical model) and a word level model (linguistic model). The linguistic model specifies the a priori likelihood that certain sequences of words will be spoken. This is specified for example in terms of the probability with which certain words are normally used, or the probability with which a specific word is followed by another specific word or the probability with which sets of N successive words occur together etc. These probabilities are entered into the model, for example using estimates obtained in a learning phase. It is not relevant for the invention how these probabilities are obtained.

The lexical model specifies for each word the successive types of the states in the sequences of states that can correspond to the word and with what a priori likelihood such sequences will occur for that word. Typically, the model specifies for each state the next states by which this state can be followed if a certain word is present in the speech signal and with what probabilities different next states occurs. The model may be provided as a set of individual sub-models for different words, or as a single tree model for a collection of words. Typically a Markov model is used with probabilities specified for example during a learning phase. It is not relevant for the invention how these probabilities are obtained.

During recognition the recognition unit 25 computes an aposteriori likelihood of different sequences of states and words from an apriori likelihood that the sequence of words occurs, an apriori likelihood that the sequence of words corresponds to the sequence of states and a likelihood that states correspond to the parameters which have been determined for the different segments. As used herein “likelihood” describes any measure representative of a probability. For example a number which represents a probability times a known factor will be called a likelihood, similarly, the logarithm or any other one to one function of a likelihood will also be called a likelihood. The actual likelihood used is a matter of convenience and does not affect the invention.

Recognition unit 25 does not compute likelihoods for all possible sequences of words and sequences of states, but only those which recognition unit 25 finds to be more likely to be the most likely sequence.

FIG. 3 illustrates sequences of words and states for the computation of likelihoods. The figure shows states as nodes 30a-c, 32a-f, 34a-g for different segments of the speech signal (only some of the nodes have been labeled for reasons of clarity). The nodes correspond to states specified in the lexical model that is used for recognition. Different branches 31a-b from a node 30a indicate possible transitions to subsequent nodes 30b-c. These transitions correspond to succession of states in sequences of states as specified in the lexical model. Thus, time runs from left to right: nodes for segments with increasingly later starting time being shown increasingly further to the right.

When the recognition unit 25 searches for sequences of states to represent words, it determines which states it will consider. For these states it reserves memory space. In the memory space it stores information about the type of state (e.g. by reference to the lexical model), its likelihood and how it was generated. Showing of nodes in FIG. 3 symbolizes that the recognition unit has reserved memory and stored information for the corresponding states. Therefore, the words nodes and states will be used interchangeably. Starting from a state 30a for which it has stored information, the recognition unit 25 decides whether and for which next states allowed by the model it will reserve memory space (this is called “generating nodes”). The states 30b-c for which the recognition unit 25 does so are represented by nodes connected by branches 31a-b from the previous node 30a. Recognition unit 25 may store information about the previous node 30a in the memory reserved for the state represented by a node 30a,b, but instead relevant information (such as an identification of the starting time of the word being recognized and the word history before that starting time) may be copied from that previous node 30a.

From the nodes 30b-c transitions may occur to subsequent nodes are possible and so on. Thus, different sequences of states are represented, with transitions between bodes that represent successive states in the sequence. These sequences reach terminal states (represented by terminal nodes 32a-f) of words, for which the lexical model indicates that the sequence of states for a particular word ends.

Each terminal node 32a-f is shown to have a transition 33a-f to an initial node 34a-f of a sequence of states for a next word. Different initial nodes 34a-f are shown in different bands 35a-g which will be referred to as “searches” 35a-g, which will be discussed in more detail shortly. In each of the searches 35a-g sequences of states occur, which end in terminals nodes 32a-f. From these terminal nodes 32a-f other transitions occur to initial nodes in subsequent searches 34a-f and so on.

From a terminal node 32a-f in a search 35a-g one can trace back in the search 35a-g to the initial node 34a-f at the start of the (sub-)sequence that ends in the terminal node 32a-f and from there to the previous terminal node 32a-f. Thus a sequence of terminal nodes 32a-f can be identified for any terminal node 32a-f. Each terminal node 32a-f in such a sequence corresponds to a tentatively recognized word. Each terminal node 32a-f therefore also corresponds to a sequence of tentatively recognized words. From these sequences of words more likely sequences of word are selected using the linguistic model and less likely sequence are discarded. In one prior art technique this is done for example by discarding each time all but the most likely sequence (or a number of more likely sequences) from a number of sequences that start with different least recent words but that otherwise contain the same words.

In one example, the recognition unit 25 generates the nodes as a function of time, that is, from left to right in the figure and for each newly generated node recognition unit selects one preceding node for which a transition is generated to the newly generated node. The preceding node is selected so that it yields the sequence with highest likelihood when followed by the newly generated node. For example, if one computes a likelihood L(S,t) of a sequence up to a state S at a time t according to

L(S,t)=P(S,S)L(S,t−1)

(where S′ is the preceding state, and P(S,S′) is the probability that a state of the type of state S′ is followed by a state of type S) then for the state S that preceding state S′ is selected from the available states that results in the highest L(S,t) and a state transition between S and this S′ is generated. Thus transitions that represent less likely sequences of states are not selected. That is, they are not considered (or “discarded”) in the search for the most likely sequence. Without deviating from the invention other methods of discarding sequences of states may be used, for example computing the likelihood of sequences of states up to a point in time and adding states only to those sequences whose likelihood is within a threshold distance from the likelihood of the most likely sequence (in this case the same state may occur more than once for the same point in time).

Once recognition unit 25 generates a terminal state 32a-f in a search 35a-g, the recognition unit 25 identifies the word corresponding to that terminal state 32a-f. Thus recognition has tentatively recognized that word ending at the time point for which the terminal state 32a-f was generated. Since recognition unit 25 may generate many terminal states at many points in time in the same search 35a-g, it does not generally recognize a single word or even a single ending time point for the same word in a search 35a-g.

The significance of searches 35a-g will now be discussed in more detail. After detecting the terminal state 32a-f, recognition unit 25 will enter a new search 35a-g for a more likely sub-sequence of states following the terminal state 32a-f of the previous search 35a-g in time (such sub-sequences of states will be referred to as sequences where this does not lead to confusion). The new search is preferably a so-called “tree search” in which a tree model is used, which allows for searching sequences of states for all possible words at once in the same search. This is the case shown in the figure. But without deviating from the invention, the new search may also be a search for likely states that represent a selected word or set of words.

In the same new search 35a-g initial states 34a-f are generated following different terminal states 32a-f. These different terminal states include for example different terminal states 32a-f corresponding to the same word in the same search, but occurring at different points in time. The initial states 34a-f in the new search may also include initial states 34a-f that follow terminal states 32a-f from various searches 35a-g. In general, initial states 34a-f that follow final states 32a-b from a predefined class of sequences will be included in the same search 35a-g. Terminal states 32a-f from different classes will have transitions to initial states in different searches 35a-g.

Within a search 35a-g and during selection of sequence of states for which the likelihood will be computed the recognition unit 25 will discard (not extend) less likely sequences. Thus sequences of states that start from one initial state in the search 35a-g may be discarded when a sequence starting from other initial state in the search 35a-g is more likely. Only initial states 34a-f within the same search 35a-g compete with each other in this way. Thus, for example, if initial states 34a-f for different starting times are included in the search, a most likely starting time may be selected by comparing likelihoods of sequences starting from initial states 34a-f that follow terminal states 32a-f corresponding to the same word from the same previous search for different times. (If only one starting time is allowed per search, selection of the best preceding final state may still be made within each search 35a-g. In this case selection of the optimal starting time occurs after the end of the search 35a-g, when sequences from different searches may be combined into new searches). The likelihood of a sequence in one search 35a-g will not influence the selection of individual sequences that are to be discarded in another search 35a-g.

That is, recognition unit 25 executes the different searches 35a-g effectively separated from one another. This means that generation and discarding of sequences in one search 35a-g does not affect generation and discarding in another search 35a-g, at least until a terminal state 32a-f has been reached. For example, in the example where one predecessor state is selected for each newly generated state at a point in time, new states are generated for each search 35a-g and for each newly generated state in each search 35a-g a predecessor state is selected from that search.

It should be noted that, although the searches 35a-g are “separate” in the sense that generation and discarding in one search does not affect other searches, the searches 35a-g need not be separate in other ways as well. For example, the information representing nodes from different searches may be stored intermingled in memory, data in the information indicating to which search a node belongs, for example by identifying the word history (or class of word histories) that precedes the node. In another example, generating and discarding nodes for different ones of the searches 35a-g may also be executed by processing nodes of different searches 35a-g intermingled with each other, as long as account is taken where necessary of the search 35a-g to which the node belongs.

A first aspect of the invention is concerned with selection of a class of sequences that have transitions to the same new search 35a-g. In the prior art the same new search follows terminal states that correspond to the same history of N words (as can be determined by tracing back along the sequence that resulted in that terminal node 32a-f). From a terminal node 32a-f that corresponds to a most recent history of N particular words, in the prior art a transition occurs to a search space that corresponds to the word W preceded by N−1 of these particular N words except the least recent one.

Thus, in the prior art terminal nodes 32a-f from different searches 35a-g may have a transition 33a-f to a specific next search if the terminal nodes correspond to the same N preceding words. From terminal nodes that occur for the same point in time the most likely terminal node is selected and given a transition 33a-f to the initial node in the next search. This is done for each point in time separately. The most likely terminals nodes 32a-f for each point in time (from any of these searches 35a-g) has a transition its own initial nodes the new search 35a-g. This allows the new search 35a-g to search for a most likely combination of a starting time and a new word.

In this way the number N of words in the history has a significant effect on the computational effort. As N is set increasingly larger, the number of different histories increases and thereby the number of searches increases. However keeping N small (to keep the computational effort within bounds) decreases reliability, as it may lead to discarding of word sequences that might have proved more likely in view of subsequent speech signals. Moreover, in the prior art, if a single pass technique is used N is determines the linguistic model as an N-gram model. Choosing a smaller N reduces the quality of this model.

The invention aims to reduce the number of searches while not unduly reducing quality. According to the invention a class of sequences that have transitions 33a-f to the same search 35a-g is selected on the basis of phonetic history rather than on the basis of an integer number of most recently recognized words.

The invention is based on the observation that the most likely starting time of a word will generally be the same for different histories that end in the same phonetic history. Effectively, each new search 35a-g is affected by the previous searches 35a-g only in that these previous searches 35a-g specify the likelihood of different starting times of a new word. This allows the new search to search for a most likely combination of a starting time and identity of the new word. The most likely starting time of a word will generally be the same for different histories that end in the same phonetic history and that the reliability of the starting time found in the search will depend on the length of the phonetic history considered. A word history of a fixed number of words may contain a longer phonetic history if the words are long and a shorter phonetic history if the words are short. Thus, the reliability will vary with the size of the words if a fixed length word history is used to select a search, as in the prior art. To obtain a minimum reliability the prior art needs to set the length of the history for the worst case (short words) with the result that the computational effort is unnecessarily large if longer words occur in the history. By selecting the search based on phonetic history the number of searches to attain a minimum reliability can be better controlled.

To distinguish on the basis of phonetic history, recognition unit 25 uses for example stored information that identifies the phonemes that make up different words and checks that the sequences in the class all correspond to word histories in which a predetermined number of most recent phonemes in the recognized words is the same. The predetermined number is selected irrespective of whether these phonemes occur in a single word or spread over more than one word, or whether the phonemes together make up whole words or an incomplete fraction of a word. Thus, if the terminal node 32a-f corresponds to a short word, the recognition unit 25 will use phonemes from more words in the sequence of state that leads to the terminal node 32a-f to select the class to which the terminal node 32a-f belongs than if the terminal node 32a-f corresponds to a longer word.

In one embodiment, this predetermined number of phonemes that is used to distinguish classes is set in advance. In another embodiment, the number of phonemes that is used to determine the class depends on the nature of the phonemes, for example so that these phonemes include at least a consonant, or at least a vowel or at least a syllable or combinations thereof.

FIG. 4 illustrates a search in which different terminal nodes 40 may all have a transition 42 to the same initial node 44 in a new search 46. According to one aspect of the invention the likelihood of the most likely of those terminal nodes 40 (or for example the likelihood of the nth most likely terminal node, or an average of the likelihood of a number of more likely nodes) is used to control discarding of sequences starting from the initial node 44 in the new search 46. Information is retained about a relation between the likelihoods of the less likely terminal nodes 40 and likelihood used in the search, for example in the form of a ratio Ri between the likelihoods Li, Lm of the less likely node “i” and the likelihood Lm that is used in the search 46:

Ri=Li/Lm

When the search 46 reaches a terminal node 48, this information is used to regenerate likelihood information for individual members of the class of previous sequences that all have transitions 42 to the initial node 44 at the start of the sequence that ends in the terminal node 48. This is done for example by reintroducing the factor Ri. Let L′m be the likelihood computed for the terminal node 48 during the search 46, computed for a sequence starting from a initial node 44 with a likelihood based for example on the most likely terminal node 40 that has a transition 42 to the initial node 44. Then from the likelihood L′m of the newly found terminal node 48 likelihoods for a plurality of word histories “i”, corresponding to the word histories associated by terminal nodes 40 followed by the word recognized in the search 46 are computed from

L′i=RiL′m

(Ri being the factor determined for the terminal node 40 associated with the relevant history). The regenerated likelihoods L′i for different histories “i” are used when the likelihood of different sequences up to the terminal node is computed using the linguistic model. Thus, each single sequence in the search 46 actually represents a class of histories but only requires the computational effort for a single history during the search 46. This significantly reduces computational effort with serious loss of reliability.

It can be shown that this way of regenerating likelihood information for the nodes retrieves the correct likelihood if it may be assumed that the most likely starting time of the search 35a-g is the same for all members of the class.

This second technique (performing a search for one member of a class and regenerating the likelihoods of individual members of the class at the end of the search performed for the most likely member of the class) is preferably combined with the first technique (performing joint searches 35a-g for classes of word histories that share a same phonetic history). Thus the first technique may be combined with the use of individually different likelihoods for different members of the phonetically selected classes that start at an initial node for the same time point. However, the second technique may also be used for different kinds of classes, not necessarily selected using the first technique, to reduce search effort.

FIG. 5 illustrates application of the second technique at the subword level. The figure shows sequences of nodes and transitions in a search. In the lexical model that is used to generate the sequences, certain states are labeled as subword boundaries. These correspond for example to points of transition between phonemes. The boundary nodes 50 that represent such states are indicated in the figure.

For each time point in the search, the recognition unit detects whether boundary nodes 50 have been generated. If so, the recognition unit identifies classes 52a-d of boundary nodes, where all boundary nodes 50 in the same class 52a-d are preceded by sequences of states that correspond to a common phonetic history specific for the class, for example of a predetermined number of phonemes. The recognition selects a representative boundary node from each class (preferably the node with the highest likelihood) and continues the search from only the selected boundary nodes 50 of the class 52a-d. For each other boundary nodes 50 in the class information is stored, such as a factor, that relates the likelihood of the relevant boundary node to the likelihood of the boundary node from which the search is continued.

When the search subsequently reaches another boundary node 54 or a terminal node 56 from the representative boundary node in the class, likelihood is regenerated for the other members of the class by factoring the likelihood of the new boundary node 54 or terminal node 56 with the various factors of the other class members. Subsequently the class selection process is repeated and so on.

It will be appreciated that the computational effort is considerably reduced in this way, because new nodes have to be generated only for a representative of a class of nodes.

1. A speech recognition method that comprises searching, among composite sequences that are each composed of consecutive sequences of states, for at least one of the composite sequences that is more likely to represent an observed speech signal than other ones of the composite sequences, said searching comprising
progressive, likelihood limited searches, each likelihood limited in a respective search space containing a subset of the sequences of states, for sequences of states of which the composite sequences will be composed;
the search spaces of different ones of the searches each comprising sequences of states that are to form part of a class composite sequences, different classes, defining different ones of the search spaces, being distinguished on the basis of an identity of a number of words or parts thereof represented by the sequences of states in the composite sequence up to the sequence of states in the search space, the number of words or parts thereof whose identity is used to distinguish different classes being varied depending on a length of one or more last words represented by the composite sequence up to the sequence in the search space, composite sequences that correspond to a same one or more last words are distinguished into different classes if the one or more of the last words are relatively shorter but are not distinguished into different classes if the one or more last words are relatively longer.

2. A speech recognition method according to claim 1, wherein the different classes are distinguished on a phonetic basis so that each class contains composite sequences that correspond to an own set of last phonemes, represented by the sequences of states comprising the composite sequences up to the sequence of states in the search, different classes corresponding to different sets of last phonemes, composite sequences being distinguished into different classes and/or put in a same class irrespective of the word or words of which the phonemes are part.

3. A speech recognition method according to claim 1, wherein the different classes are distinguished so that each class contains composite sequences that are the same in a predetermined number N of last phonemes, represented by the sequences of states comprising the composite sequences up to the sequence of states in the search, different classes corresponding to different N last phonemes, irrespective of the word or words of which the phonemes are part.

4. A speech recognition method according to claim 1, wherein the different classes are distinguished so that each class contains composite sequences that are the same in a number of last phonemes, represented by the sequences of states comprising the composite sequences up to the sequence of states in the search, where the number of last phonemes is selected so that it contains at least one syllable ending, different classes corresponding to different last phonemes with a syllable ending, irrespective of the word or words of which the phonemes are part.

5. A speech recognition method according to claim 1, comprising selecting more likely composite sequences and discarding other composite sequences from further search, on the basis of a word level model that specifies likelihoods of sequences of M words, corresponding to M respective consecutive sequences of states in the composite sequences, the M words being longer than the number of words or parts thereof that distinguish the composite sequences into different ones of the classes, at least one of the searches for a particular one of the classes involving joint likelihood limitation of the search for different composite sequences corresponding to different N last words represented by the sequences of states composite sequences up the sequence of states in the search, said selecting or more likely composite sequences for further search among the composite sequences in the particular class being performed after reaching a terminal state in the at least one of the searches.

6. A speech recognition method according to claim 1, wherein a particular one of the searches comprises
entering a joint sequence of states in the particular one of the searches for a plurality of composite sequences which all have a terminal node for a same point in time at an end of a last sequence of states up to the joint sequence, the joint sequence of states being assigned an initial likelihood that is representative for the plurality of composite sequences;
discarding less likely sequences of states and retaining one or more likely sequences of states in the particular one of the searches on the basis of likelihood information for the states in the sequences of states;
computing the likelihood information for each retained sequence of states incrementally for each successive state in the retained sequence of states as a function of the observed speech signal and the likelihood information for a preceding state in the retained sequence of states and repeating the discarding step;
the method comprising
regenerating further likelihood information for the individual composite sequences in the plurality of composite sequences upon reaching a terminal state of the particular one of the searches, the further likelihood corresponding to the likelihood of the terminal state when the initial state of the joint sequence leading to the terminal state is preceded by respective ones of the individual composite sequences;
performing further searches, wherein said computing and discarding during the further state level searches is based on the further likelihood information.

7. A speech recognition method according to claim 6, wherein the further likelihood information is computed from terminal likelihood information computed incrementally for the terminal state on the basis of the representative likelihood, by applying correction factors for the individual composite sequence to the terminal likelihood information.

8. A speech recognition method that comprises searching, among composite sequences that are each composed of consecutive sequences of states, for at least one of the composite sequences that is more likely to represent an observed speech signal than other ones of the composite sequences, said searching comprising
progressive, likelihood limited searches, each likelihood limited in a respective search space containing a subset of the sequences of states, for sequences of states of which the composite sequences will be composed;
wherein a first one of the searches comprises
entering a joint sequence of states in the first one of the searches for a plurality of composite sequences which all have a terminal node for a same point in time at an end of a last sequence of states up to the joint sequence, the joint sequence of states being assigned an initial likelihood that is representative for the plurality of composite sequences;
discarding less likely sequences of states and retaining one or more likely sequences of states in the first one of the searches on the basis of likelihood information for the states in the sequences of states;
computing the likelihood information for each retained sequence of states incrementally for each successive state in the retained sequence of states as a function of the observed speech signal and the likelihood information for a preceding state in the retained sequence of states and repeating the discarding step;
the method comprising
regenerating further likelihood information for the individual composite sequences of the plurality upon reaching a terminal state of the first one of the searches, the further likelihood corresponding to the likelihood of the terminal state when the initial state of the sequence leading to the terminal state is preceded by respective ones of the individual composite sequences of the plurality;
performing further searches, wherein said computing and discarding during the further searches is based on the further likelihood information for the individual composite sequences.

9. A speech recognition method that comprises searching, among composite sequences that are each composed of consecutive sequences of states, for at least one of the composite sequences that is more likely to represent an observed speech signal than other ones of the composite sequences, each sequence of states representing a word, said searching comprising
progressive, likelihood limited searches, each likelihood limited in a respective search space containing a subset of the sequences of states, for sequences of states of which the composite sequences will be composed;
identifying states corresponding to subword boundary states in said sequences of states;
identifying a class of said subword boundary states for respective ones of the sequences of states and occurring for a common time point in the speech signal, the respective ones of the sequences of states all being part of respective composite sequences made up of sequences of states that represent phonetically equivalent histories ending at the common point in time;
continuing the progressive, likelihood limited search from a single successor state shared by all subword boundary states in the class, using for said single successor state likelihood information representative for the class, to compute likelihood information for subsequent states and to control subsequent search until a next subword boundary state or a terminal state is identified;
computing multiple likelihood information for said next subword boundary state or terminal state, corresponding to the sequence of states preceding said next subword boundary state or terminal state when including respective members of the class of subword boundary states;
performing further search, said further search individually using likelihood information computed for the respective members.

10. A speech recognition method according to claim 9, wherein subword boundary states that are members of the class are distinguished from subword boundary states that are not members of the class on the basis of differences between sequences of preceding states that extend through the composite sequence beyond a starting state of the sequence of states of which the subword boundary state is part, so that the classes are distinguished based on a predetermined amount of phonetic history, independent of whether this phonetic history extends over a word boundary.

11. A speech recognition system
an input for receiving a speech signal;
a recognition unit arranged to search, among composite sequences that are each composed of consecutive sequences of states, for at least one of the composite sequences that is more likely to represent an observed speech signal than other ones of the composite sequences, said searching comprising progressive, likelihood limited searches, each likelihood limited in a respective search space containing a subset of the sequences of states, for sequences of states of which the composite sequences will be composed;
the recognition unit starting different ones of the searches for search spaces that each comprise sequences of states that are to form part of a class composite sequences, different classes, defining different ones of the search spaces, being distinguished on the basis of an identity of a number of words or parts thereof represented by the sequences of states in the composite sequence up to the sequence of states in the search space, the number of words or parts thereof whose identity is used to distinguish different classes being varied depending on a length of one or more last words represented by the composite sequence up to the sequence in the search space, composite sequences that correspond to a same one or more last words are distinguished into different classes if the one or more of the last words are relatively shorter but are not distinguished into different classes if the one or more last words are relatively longer.

12. A speech recognition system according to claim 11, wherein the recognition unit distinguishes the different classes on a phonetic basis so that each class contains composite sequences that correspond to an own set of last phonemes, represented by the sequences of states comprising the composite sequences up to the sequence of states in the search, different classes corresponding to different sets of last phonemes, composite sequences being distinguished into different classes and/or put in a same class irrespective of the word or words of which the phonemes are part.

13. A speech recognition system according to claim 11, wherein the recognition unit distinguished the different classes so that each class contains composite sequences that are the same in a predetermined number N of last phonemes, represented by the sequences of states comprising the composite sequences up to the sequence of states in the search, different classes corresponding to different N last phonemes, irrespective of the word or words of which the phonemes are part.

14. A speech recognition method according to claim 11 wherein the speech recognition unit distinguishes different classes so that each class contains composite sequences that are the same in a number of last phonemes, represented by the sequences of states comprising the composite sequences up to the sequence of states in the search, where the number of last phonemes is selected so that it contains at least one syllable ending, different classes corresponding to different last phonemes with a syllable ending, irrespective of the word or words of which the phonemes are part.

15. A speech recognition system according to claim 11, the recognition unit selecting more likely composite sequences and discarding other composite sequences from further search, on the basis of a word level model that specifies likelihoods of sequences of M words, corresponding to M respective consecutive sequences of states in the composite sequences, the M words being longer than the number of words or parts thereof that distinguish the composite sequences into different ones of the classes, at least one of the searches for a particular one of the classes involving joint likelihood limitation of the search for different composite sequences corresponding to different N last words represented by the sequences of states composite sequences up the sequence of states in the search, said selecting or more likely composite sequences for further search among the composite sequences in the particular class being performed after reaching a terminal state in the at least one of the searches.

16. A speech recognition system according to claim 11, the recognition unit being arranged to perform a particular one of the searches so as to
enter a joint sequence of states in the particular one of the searches for a plurality of composite sequences which all have a terminal node for a same point in time at an end of a last sequence of states up to the joint sequence, the joint sequence of states being assigned an initial likelihood that is representative for the plurality of composite sequences;
discard less likely sequences of states and retain one or more likely sequences of states in the particular one of the searches on the basis of likelihood information for the states in the sequences of states;
compute the likelihood information for each retained sequence of states incrementally for each successive state in the retained sequence of states as a function of the observed speech signal and the likelihood information for a preceding state in the retained sequence of states and repeating the discarding step;
the recognition unit
regenerating further likelihood information for the individual composite sequences in the plurality of composite sequences upon reaching a terminal state of the particular one of the searches, the further likelihood corresponding to the likelihood of the terminal state when the initial state of the joint sequence leading to the terminal state is preceded by respective ones of the individual composite sequences;
performing further searches, wherein said computing and discarding during the further state level searches is based on the further likelihood information.

17. A speech recognition system according to claim 16, wherein the further likelihood information is computed from terminal likelihood information computed incrementally for the terminal state on the basis of the representative likelihood, by applying correction factors for the individual composite sequence to the terminal likelihood information.

18. A speech recognition system comprising
an input for receiving a speech signal;
a recognition unit arranged to search, among composite sequences that are each composed of consecutive sequences of states, for at least one of the composite sequences that is more likely to represent an observed speech signal than other ones of the composite sequences, said searching comprising progressive, likelihood limited searches, each likelihood limited in a respective search space containing a subset of the sequences of states, for sequences of states of which the composite sequences will be composed;
wherein a first one of the searches comprises
entering a joint sequence of states in the first one of the searches for a plurality of composite sequences which all have a terminal node for a same point in time at an end of a last sequence of states up to the joint sequence, the joint sequence of states being assigned an initial likelihood that is representative for the plurality of composite sequences;
discarding less likely sequences of states and retaining one or more likely sequences of states in the first one of the searches on the basis of likelihood information for the states in the sequences of states;
computing the likelihood information for each retained sequence of states incrementally for each successive state in the retained sequence of states as a function of the observed speech signal and the likelihood information for a preceding state in the retained sequence of states and repeating the discarding step;
the recognition unit
regenerating further likelihood information for the individual composite sequences of the plurality upon reaching a terminal state of the first one of the searches, the further likelihood corresponding to the likelihood of the terminal state when the initial state of the sequence leading to the terminal state is preceded by respective ones of the individual composite sequences of the plurality;
performing further searches, wherein said computing and discarding during the further searches is based on the further likelihood information for the individual composite sequences.

19. A speech recognition system comprising
an input for receiving a speech signal;
a recognition unit arranged to search, among composite sequences that are each composed of consecutive sequences of states, for at least one of the composite sequences that is more likely to represent an observed speech signal than other ones of the composite sequences, each sequence of states representing a word, said searching comprising progressive, likelihood limited searches, each likelihood limited in a respective search space containing a subset of the sequences of states, for sequences of states of which the composite sequences will be composed, the recognition unit being arranged to
identify states corresponding to subword boundary states in said sequences of states;
identify a class of said subword boundary states for respective ones of the sequences of states and occurring for a common time point in the speech signal, the respective ones of the sequences of states all being part of respective composite sequences made up of sequences of states that represent phonetically equivalent histories ending at the common point in time;
continue the progressive, likelihood limited search from a single successor state shared by all subword boundary states in the class, using for said single successor state likelihood information representative for the class, to compute likelihood information for subsequent states and to control subsequent search until a next subword boundary state or a terminal state is identified;
compute multiple likelihood information for said next subword boundary state or terminal state, corresponding to the sequence of states preceding said next subword boundary state or terminal state when including respective members of the class of subword boundary states;
perform further search, said further search individually using likelihood information computed for the respective members.

20. A speech recognition system according to claim 19, wherein subword boundary states that are members of the class are distinguished from subword boundary states that are not members of the class on the basis of differences between sequences of preceding states that extend through the composite sequence beyond a starting state of the sequence of states of which the subword boundary state is part, so that the classes are distinguished based on a predetermined amount of phonetic history, independent of whether this phonetic history extends over a word boundary.
